(19) United States
(12) Patent Application Publication
(10) Pub. No.: US 2015/0143067 A1
(43) Pub. Date: May 21, 2015

(54) METHOD AND SYSTEM FOR QUALIFICATION OF AN ELEMENT

(71) Applicants: Pierre GERMAIN, Bouc Bel Air (FR); Yannick Winling, Aix en Provence (FR); Ronan Joncour, Aix en Provence (FR)

(72) Inventors: Pierre GERMAIN, Bouc Bel Air (FR); Yannick Winling, Aix en Provence (FR); Ronan Joncour, Aix en Provence (FR)

(73) Assignee: GERWIN SARL, Aix en Provence (FR)

(21) Appl. No.: 14/546,257

(22) Filed: Nov. 18, 2014

Related U.S. Application Data
(63) Continuation of application No. 13/234,246, filed on Sep. 16, 2011.

(30) Foreign Application Priority Data
Sep. 16, 2010 (FR) FR1057423

(51) Int. Cl. G06F 12/14

(52) U.S. Cl. CPC G06F 12/1483; G06F 2212/1052
USPC 711/163

(57) ABSTRACT

A method and a system for creating and qualifying one or more elements, such as multimedia content or, more generally, a performance by an author. The invention more particularly aims at associating a qualification level with an element so that a consultation work can be available, as regards relevance, robustness, skills and authorisation, and thus a degree of objective reliability can be granted to said element. Preferably, the invention relates to the generation of a bank of elements such as questions for television or radio quiz shows, on-line games, etc.

The invention relates to a method and a system for the on-line creation and qualification of one or more elements, such as multimedia content or, more generally, a performance by an author. The invention more particularly aims at associating a qualification level with an element so that a consultation work can be available, as regards relevance, robustness, skills and authorisation, and thus a degree of objective reliability can be granted to said element.

According to a preferred embodiment, the invention relates to the quality management of elements such as questions for television or radio quiz shows, on-line games through the Internet or an intranet, or more generally, questions reproduced on all types of media (newspapers, magazines etc.). An element—in the sense of the invention—can also consist of music score, music extract, multimedia work, an examination paper, an answer document etc. The invention thus makes it possible to validate such an element, and optionally to improve, correct, enrich or evaluate it.

Referring to the state of the art as regards the creation of quiz questions, for example, various solutions exist, among which we can first mention the existence of a select college of actors that produce questions written by a few hand-picked persons who are assumed to be perfectly capable of writing relevant questions. This method has several major disadvantages. First of all, a few experts are trusted at the risk of writing an erroneous or ambiguous question. Further, this approach generally entails a low turnover of questions due to the low number of writers, and thus to the exhaustion of a topic. This also entails high costs, since recruiting such experts is not easy.

To remedy these disadvantages, some actors have created a discussion group. This solution aims at calling on the largest number of persons by giving a group subscriber the possibility of submitting questions. Using this technique allows question coverage to be enriched, but generates a large quantity of often redundant questions, the relevance and/or veracity of which may be debatable and heterogeneous. To remedy this disadvantage, restricted or moderating groups have been created, where only the most learned are authorised to submit or accept questions, but this solution rapidly revealed that the above mentioned disadvantages (topics weakness, absence of control etc.) always come up, since a minority of experts cannot cover the flood of questions suggested. Further, the selection of the panel of said experts remains arbitrary and questionable.

The invention aims at remedying the disadvantages of the prior art by providing a system and a method for the qualification of a multimedia element, making it possible for a large number of interveners to suggest questions or any other type of content, and also to consult, correct, improve and validate said types of content. The invention thus makes it possible to multiply the number of interveners, the expertise and the richness, the quality and the relevance of the produced elements. According to various alternative solutions, the invention enables each intervener to securely participate on-line and remotely regardless of his/her place of residence. The invention further makes it possible to qualify said interveners and to gain their loyalty thanks to innovative promotion mechanisms.

For this purpose, the invention provides a method for processing a request sent to an element qualification management system, with said method being implemented by said system. Such a method comprises:
a first step of creating at least one directory of at least one element in order to associate with one element of the directory a unique identifier and an attribute, the current value of which describes a qualification level belonging to a group of at least two distinct values;
a step of receiving a request for access to a directory;
a step of processing said request.

The invention provides that:
a first created elements directory is an interveners' directory whose qualification level value belongs to a group G_{I} of at least two distinct values;
the request includes the identifier of the intervener making the request;
said method further includes a preliminary step of customizing means for controlling said management system in order to determine the qualification level required for any intervener making a request to have access to a directory of the system;
the step of processing the request consists in:
decoding said request in order to know the identifier of the intervener making the request;
consulting the interveners' directory in order to know the qualification level of the intervener making the request;
authorizing the requested access to the directory for which the request has been made if the control means confirms that the qualification level of the intervener making the request allows the latter to legitimately request such an access.

According to a first embodiment, the request for access may be a request for assignment in order to assign a value q—belonging to the group G_{I}—to the attribute describing the qualification level associated with an element in the interveners' directory as a substitution for the latter's current qualification level. According to this embodiment:
the preliminary step of customizing the control means may consist in determining the value or values q, the assignment of which can be requested by an intervener depending on his/her qualification level;
the step of processing the request may enable to assign the requested value q to the attribute for describing the qualification level associated with the element for which the request has been made if the control means confirms that the qualification level of the intervener making the request allows the latter to legitimately request such an assignment.

According to an alternative solution, the invention provides that:
a second created elements directory may be a contents directory whose qualification level value belongs to a group G_{C} of at least two distinct values;
the request for access may be a request for assignment in order to assign a value q to the attribute describing the qualification level associated with a content of said contents directory as a substitution for the latter's current qualification level.

According to this alternative solution:
the preliminary step of customizing the control means may consist in determining the value or values q of the qualification levels belonging to the group G_{C}, the assignment of which can be requested by an intervener depending on his/her qualification level;
the step of processing the request may enable to assign the value q to the attribute in order to describe the qualification level of the content for which the request has been made if the control means confirms that the qualification level of the intervener making the request allows the latter to legitimately request such an assignment.

The invention further provides that the request for access may consist of a request for consultation of directory information associated with one or more directory elements. In this case:
the preliminary step of customizing the control means may consist in determining the value or values of the levels of authorisation necessary to consult one or more pieces of information associated with an element from an elements directory;
the step of processing the request may enable to provide one or more pieces of information from a directory if the control means confirms that the qualification level of the intervener making the request allows the latter to legitimately request such a consultation.

The invention also provides an element qualification management system comprising:
storage means for saving at least one directory of at least one element in order to associate with one element of a directory, a unique identifier and an attribute, the current value of which describes a qualification level belonging to a group of at least two distinct values;
means for receiving a request for access to a directory;
means for processing said request.

According to the invention:
a first created elements directory is an interveners' directory the respective qualification level value of which belongs to a group G_{I} of at least two distinct values;
said system further includes control means for determining the qualification level required for any intervener making a request to have access to a directory of the system;
the means for processing a request—which further includes the identifier of the intervener making the request:
   decodes said request in order to know the identifier of the intervener making the request;
   consults the interveners' directory in order to know the qualification level of the intervener making the request;
   authorizes the requested access to the directory for which the request has been made if the control means confirms that the qualification level of the intervener making the request allows the latter to legitimately request such an access.

According to the invention, the storage means may further associate one or more descriptive attributes with one element of a directory.

The invention further provides that such a system may further comprise a human-machine interface module coupled with an electronic device working with said system to make a request and give the result thereof on said electronic device.

Other characteristics and advantages will appear more clearly on reading the following description and on examining the appended Figures among which:

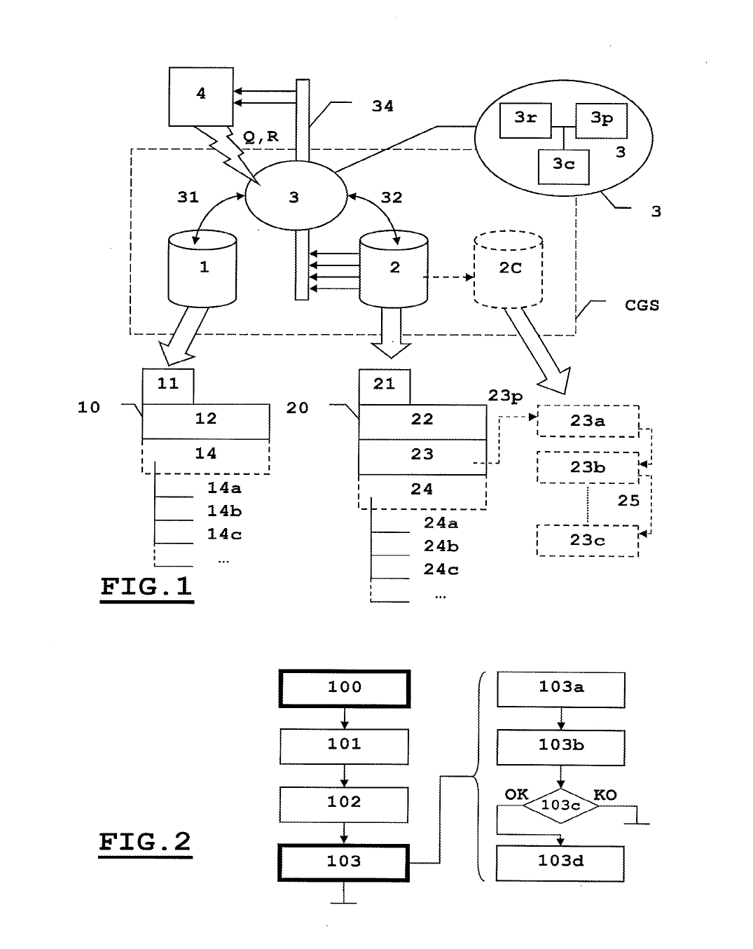

FIG. 1 shows an element qualification system according to the invention;

FIG. 2 shows an embodiment of a method for processing requests implemented by such a system;

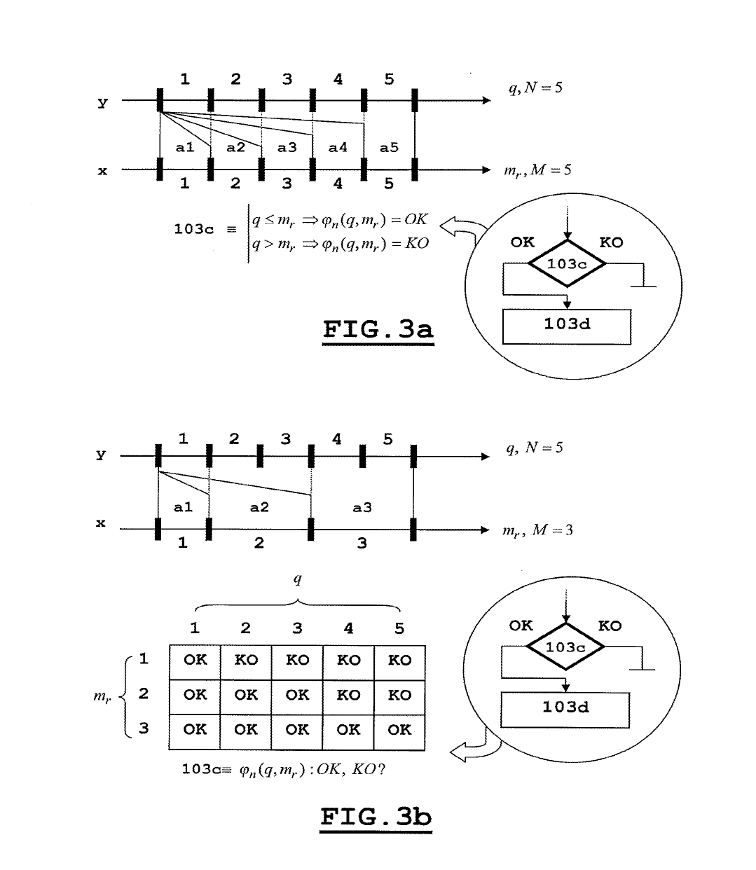

FIGS. 3a and 3b respectively show two embodiments for implementing a policy for monitoring the level of authorisation necessary to promote an element to a requested qualification level according to the invention;

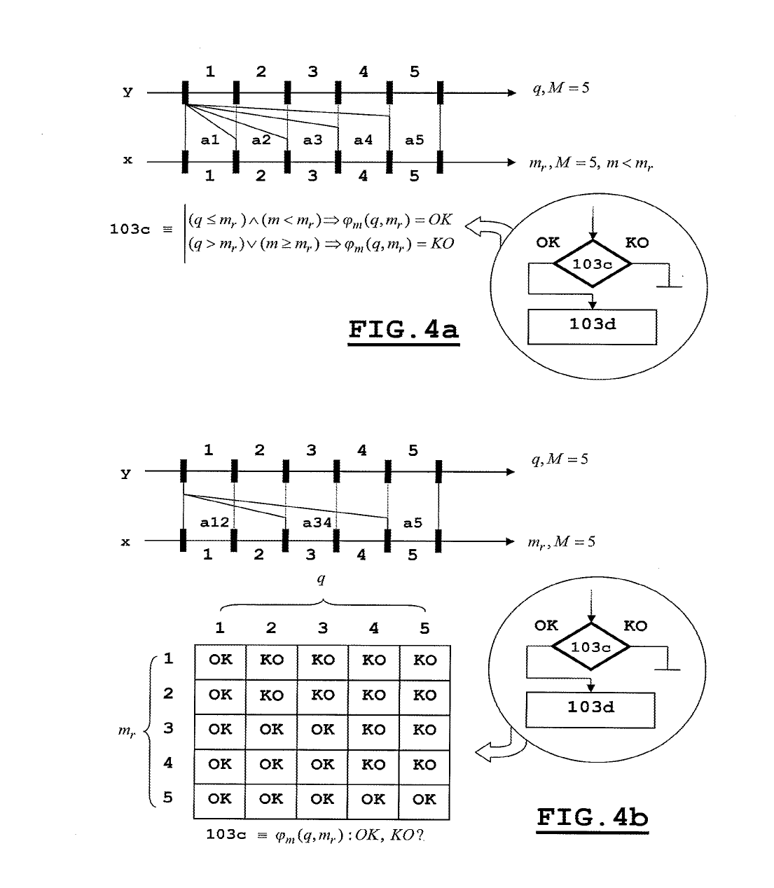

FIGS. 4a and 4b respectively illustrate two examples for implementing a policy for an internal promotion among interveners according to the invention.

FIG. 1 illustrates an embodiment of a content generation and qualification system (CGS) according to the invention.

Such a system comprises means for storing one or more element directories. Said storage means may consist of one or more hard disks of a data server.

A directory may therefore be stored in a single storage means such as a disk. As an alternative solution, a directory may be distributed over several disks in one data server or even over several data servers.

A directory allows a unique identifier and a qualification level to be associated with an element.

According to a first example, a directory 1 is dedicated to the interveners having taken out a subscription with a service provider who operates a system according to the invention. Such an intervener is given an entry 10 in the interveners' directory 1 that comprises a first field 11 for storing a unique identifier assigned to the intervener. It further comprises a field 12 for storing the intervener's current qualification level. For an intervener, the qualification level describes his/her authorisation to interact with the system: this can be referred to as an intervener's level of authorisation. In the following the current value of an intervener's level of authorization shall be noted m. Let us take the example of an i^{th} intervener having entry 10 in the interveners' directory 1. This entry comprises a first field 11 for storing an identifier of value IDIᵢ. It further comprises a field 12 for storing the level of authorisation, the current value of which is noted mᵢ.

The values m of an intervener's qualification (or authorisation) level according to the invention belong to a group of at least two distinct values. For the interveners' directory, the field 12 of an entry 10 comprises a value m belonging to a group G_{I} of at least two distinct values.

By way of example, G_{I} can describe a representative scale of 5 increasing values (1 to 5). An intervener having entry in the interveners' directory 1 and for whom the field 12 contains the value m equal to l (l being an integer between 1 and 5) can then be referred to as an intervener of level l. Any other set of values can be used instead of the considered example.

According to one alternative embodiment, an entry 10 in an interveners' directory 1 may further comprise one or more fields 14 for storing one or more descriptive attributes. By way of example, the invention thus allows an alias 14a, a seniority 14b, one or more specialities 14c etc. to be associated with an intervener. It is thus possible to describe the fields in which the intervener is particularly learned (general knowledge, history, sciences . . . ) or any other preference. Storing the number of an intervener's performances etc. using such descriptive attributes 14 can also be considered.

As shown in FIG. 1, a CGS, according to the invention, may comprise a second directory 2 dedicated to elements such as multimedia content: text, video, audio etc.

Such a directory may thus be dedicated to elements such as, for example, questions designed to be ultimately used by an on-line game during which a person is prompted to answer contextual questions via his/her web browser. The CGS enables, in this example, a bank of relevant, varied, good-quality questions to be produced, and then for said question bank to be made available to an on-line gaming operator.

A directory 2 thus comprises an entry 20 dedicated to a multimedia content—for example a question—hereinafter referred to as “content”. Such an entry 20 comprises a first field 21 for storing a unique identifier associated with the content. It further comprises a field 22 for storing said content current qualification level n. The latter corresponds—for example—to a level of relevance the current value n of which is included in a group G_{C} of at least two distinct values.

Thus, according to this example, the j^{th} content having an entry 20 in the contents directory 2 is associated with an entry 20 for storing 21 the value identifier IDCⱼ thereof. The value nⱼ of the current level of relevance is also stored 22 in said entry 20.

By way of example, G_{C} can describe a representative scale of 5 increasing values (1 to 5). A content having an entry in the contents directory 2 and for which the field 22 contains the value n equal to k (k being an integer between 1 and 5) can then be referred to as a content of level k. Any other set of values can be used instead of the considered example.

An entry 20 in a contents directory may further comprise a field 23 for storing the content itself. As an alternative solution, the field 23 may contain a consultation to a supplementary memory 2C of the CGS. In this case, the supplementary memory may contain a field 23a for storing the content. The supplementary memory 2C may be stored in a single storage means such as a disk, or as an alternative solution, it may be split over several disks in one data server or even over several data servers. The invention also allows one or more versions of the same content to be stored. Said alternative version or versions may be stored in fields 23b or 23c of the supplementary database. These different fields 23a to 23c associated with the same content may be linked 25 as indicated in the embodiment described in connection with FIG. 1.

An entry 20 in a contents directory 2 may further comprise one or more fields for storing one or more descriptive attributes 24. By way of example, the invention thus allows a title 24a, a date of creation 24b, one or more categories 24c or applications for which the content is particularly suited (type of game—for a question, for example, classification: geography, music . . . ), or any other qualitative information to be associated with a content. Storage of the alternative version or versions of the same content using such descriptive attributes 24 instead of the supplementary database 2C can also be considered. The number of consultations by one or more interveners from the interveners' directory or the identifier of the intervener/writer can also be stored. More generally, the invention allows one or more pieces of meta-information stored in a directory entry to be associated with an element (intervener or content).

A CGS further comprises processing means 3 suitable for cooperating 31 with the interveners' directory 1, but also with any other directory—such as the directory 2, or even a supplementary database 2C.

The processing means 3 are more particularly suitable for read/write-accessing said directories to consult, create or update entry in a directory. The processing means of the CGS are also suitable for receiving and implementing requests via the receiving 3r and implementation 3p means respectively.

A first request may consist of a request for assignment Q in order to assign a value q to the attribute describing the qualification level associated with one element of the directory, as a substitution for the latter's current qualification level.

The processing of such a request is illustrated through an example in connection with FIG. 2. In order to authorise or reject such as a request for assignment, the processing means of the CGS comprises control means 3c to confirm or invalidate the authorisation for the intervener requesting to update a directory entry field. The intervener from whom the request—which explicitly or implicitly includes the latter's identifier—originates is called the “intervener making the request”. Control means customization examples are shown in FIGS. 3a, 3b, 4a and 4b.

A CGS according to the invention may further receive—via the means 3r—a request for consultation R to read one or more fields in a directory entry. The invention provides that such a request may be conditional—for example, on the values of one or more attributes associated with the intervener making the request. Thus, the control means 3c may confirm or invalidate the authorisation of the intervener making the request, depending on the latter's current level of authorisation in, mᵣ—such level of authorisation being stored in the interveners' directory. The CGS may thus offer a view 34 of a directory and allow consultation to all or part of one or more entries in said directory.

An intervener—provided that he/she has access to the interveners' directory—may send requests to the CGS via all means 4 suitable for cooperating with the CGS. By way of example, the means 4 consists of a human-machine interface module for web browser aboard a personal computer.

FIG. 2 describes an example of a method implemented by a system according to the invention—such as the CGS described in connection with FIG. 1. This method allows a request for access to the information contained in a directory sent to said system to be processed. The term “access” is to be understood in the broadest sense with a view to respectively reading or modifying a directory entry field according to the invention.

The method of FIG. 2 thus allows a request for assignment or a request for consultation, such as the requests Q and R mentioned above, to be processed.

Such a method comprises a first step 101 of creating at least one directory such as the directories 1, 2 or even 2C described in connection with FIG. 1. This step consists in associating—by allotting one entry in a directory—a unique identifier and an attribute, the current value of which describes a qualification level, with at least one directory element.

A first directory created is an interveners' directory such as the directory 1 described in connection with FIG. 1. At least one intervener has entry 10 in the interveners' directory storing a current qualification level or authorisation, the value m of which belongs to a group of at least two distinct values—such as the group G_{I} described in connection with FIG. 1.

The method comprises a step 102 of receiving a request—for example a request for assignment Q—followed by a step 103 of processing said request.

A method according to the invention comprises a preliminary step 100 of customizing the management system control means according to the invention. Customization allows the necessary authorisation to be determined for an intervener whose level of authorisation is mᵣ to be able to request access to such and such field in an entry in the system directory.

The step 103 consists in:
decoding—103a—a request received in order to know the identifier of the intervener making the request;
consulting—103b—the interveners' directory to know the current level of authorisation mᵣ of the intervener making the request;
authorising —in 103d—the requested access to the directory which the request relates to if and only if the control means (such as the means 3c in connection with FIG. 1) confirms—103c—that the intervener making the request is suitably authorised to request such access.

FIG. 3a illustrates a first example of customization of the control means 3c of a management system according to the invention and described in connection with FIG. 1.

In this example, we wish to determine the authorisation of an intervener—whose current qualification level is m^{r}—capable of sending a request for assignment for assigning a value q to the attribute describing the qualification level associated with a content in a contents directory—such as the directory 2—as a substitution for the latter's current qualification level n. Following this first example, the group G_{I} comprises M=5 distinct values and may take an integer value m from 1 to 5. Schematically, FIG. 3A shows an x-axis comprising M segments respectively dedicated to a value of a current qualification level mᵣ for an intervener making a request.

Still in this example, the group G_{C} further comprises N=5 distinct values and may take an integer value n from 1 to 5 to represent a level of relevance for content. Schematically, FIG. 3A shows a y-axis comprising N segments respectively dedicated to a value of a requested level of relevance q for content.

Customizing the control means comprises determining a predicate φₙ such that:
q≦mᵣ [symbol] φₙ(q,mᵣ)=OK: an intervener with a level of authorisation mᵣ is authorised to propose a request for assignment for a level of relevance of value q less than or equal to mᵣ;
q>mᵣ [symbol] φₙ(q,mᵣ)=KO: an intervener with a level of authorisation mᵣ may not request an assignment for a level of relevance of value q greater than his/her level of authorisation mᵣ.

To illustrate the use of such a predicate graphically, FIG. 3a describes a set of five areas a1 to a5 to represent the values q allowed for an intervener whose level of authorisation mᵣ is included in G_{I}. Let us take the example of area a3. This is defined respectively by the lower and upper limits of the segment characterising mᵣ equal to 3 on the x-axis and by the lower limit of the segment characterising the minimum value of q (equal to 1) and by the upper limit of the segment characterising the maximum authorised value of q (equal to 3) on the y-axis.

In connection with FIGS. 1 and 2, while such a request for assignment Q is being processed, the step 103c implemented by the system's control means consists in accepting an update for a field 22 in an entry 20 in the contents directory 2, said field 22 saving the current level of relevance n of a content if and only if the requested level of relevance q is less than or equal to the level of authorisation mᵣ of the intervener making the request.

In the case of an application where the invention enables the qualification of quiz questions to be managed, FIG. 3a illustrates an example of authorisation policy for which a hierarchy of interveners is defined.

According to FIG. 3a, a minimum level of authorisation mᵣ equal to 1 allows an intervener to submit a new question in order to create an entry in a contents directory. Such a content level of relevance is initialised at a minimum level of relevance n, the value of which is equal to 1. A level 1 intervener may further make a request for assignment of a level of relevance equal to 1 and post a comment—or propose an amended version—for a content already having an entry in the contents directory and of which he/she is not necessarily the author. Such an intervener may thus maintain the level of relevance of a content equal to 1 or request that such level of relevance be brought down to the minimum value 1 if he/she considers the content concerned to be obviously erroneous or incomplete.

More generally, following the example of FIG. 3a, an intervener whose level of authorisation mᵣ is above 1 may legitimately request that a value q, less than or equal to his/her level of authorisation mᵣ, be assigned. He/she may thus correct, complete or even provide an alternative version for a content, and comment on his/her request.

Still following this example, the control means may—preferably—be customized so as not to compulsorily authorise a request for assignment concerning a content, the level of relevance of which is above the level of authorisation of the intervener making the request. For example a request for assignment originating from a level 2 intervener can thus be rejected if the content, the object of the request is of level 3, whatever the level requested by said intervener.

FIG. 3b illustrates an alternative solution in which:
the group G_{I} comprises M=3 distinct values and may take an integer value m from 1 to 3;
the group G_{C} comprises N=5 distinct values and may take an integer value n from 1 to 5.

Following this example, customizing the control means 3c comprises determining a truth matrix of φₙ of M rows and N columns to define the authorisations “OK” and the refusals “KO” while processing the assignment request.

Thus, according to FIG. 3b:
an intervener whose level of authorisation mᵣ is 1 may only request a new level of relevance q equal to 1;
an intervener whose level of authorisation mᵣ is 2 may only request a new level of relevance q between 1 and 3;
an intervener whose level of authorisation mᵣ is 3 may request a new level of relevance q between 1 and 5.

Similarly to FIG. 3a, FIG. 3b gives a graphic illustration of such a customization using areas a1 and a3 defined on the x and y axes comprising segments associated with the values mᵣ and q respectively.

FIG. 4a illustrates a third example of customization of the control means 3c of a management system according to the invention and described in connection with FIG. 1.

According to this example, we wish to determine the authorisation of all interveners liable to send a request for assignment for assigning a value q to the attribute describing the qualification level associated with an element of the interveners' directory—such as the directory 1—as a substitution for the latter's current level of authorisation m. In connection with FIG. 4a, the group G_{I} comprises M=5 distinct integer values between 1 and 5.

Customizing the control means means determining a predicate φₘ such that:
(q≦mᵣ) [symbol] (m<mᵣ) [symbol] φₘ(q,m)=OK: an intervener with a level of authorisation mᵣ is authorised to propose a request for assignment for a level of authorisation of value q less than or equal to mᵣ. The predicate further specifies that said authorisation may only be granted if the current level of authorisation m of the intervener, the object of the request, is also strictly less than or equal to the level of authorisation of the intervener making the request.
(q>mᵣ) [symbol] (m≧mᵣ) [symbol] φₘ(q,mᵣ)=KO: an intervener having a level of authorisation mᵣ may not request an assignment having a level of authorisation of value q greater than his/her own level of authorisation mᵣ, nor request an assignment of a level of authorisation of value q—although less than his/her own level of authorisation mᵣ—if the current level of authorisation m of the intervener, the object of the request, is greater than or equal to the level of authorisation mᵣ of the intervener making the request.

In connection with FIGS. 1 and 2, while such a request for assignment Q is being processed, the step 103c implemented by the system control means means accepting an update for a field 12 of an entry 10 in the interveners' directory 1, said field 12 saving the current level of authorisation m of an intervener if and only if the requested level of authorisation q is less than or equal to the level of authorisation mᵣ of the intervener making the request, and if the current level of authorisation m of the intervener, the object of the request, is strictly lower than said level of authorisation mᵣ of the intervener making the request.

FIG. 4b illustrates an alternative solution wherein the group G_{I} comprises M=5 distinct integer values between 1 and 5, wherein customizing the control means 3c comprises determining a truth matrix φₘ of M rows and M columns to define the authorisations “OK” and the refusals “KO” while processing the assignment request.

FIG. 4b describes an authorisation management policy for the interveners for which a hierarchy of interveners is defined:
a minimum level of authorisation mᵣ equal to 1 allows an intervener to request an assignment of a qualification level equal to 1 and optionally to suggest a comment justifying his/her suggestion. He/she may also request that an intervener's current level of authorisation be brought down to the minimum value if he/she considers said intervener concerned to be obviously inexperienced in the subject. The same is true for an intervener making a request whose level of authorisation mᵣ is 2.
An intervener whose level of authorisation mᵣ is equal to 3 or 4 may legitimately request that a value q less than or equal to his/her level of authorisation be assigned. He/she may further request that an intervener whose current level of authorisation m is equal to 1 or 2 be promoted by requesting that a value q less than or equal to his/her level of authorisation be assigned.
An intervener whose level of authorisation mᵣ is equal to 5 may legitimately request that a value q included in the group G_{I} be assigned.

The invention allows, according to a preferred embodiment, a so-called “composite” request, both relating to content's level of relevance and an intervener's level of authorisation to be sent and executed.

According to this embodiment, such a request Q comprises the identifier of the intervener making the request (or any other means allowing the latter to be identified) as well as a first value q_{c} corresponding to the requested level of relevance for a content. Said request further comprises a second value qᵢ corresponding to the requested level of authorisation for an intervener having previously participated in the process of creation and/or qualification of said content. The processing means 3 of a CGS according to the invention can then decode such a composite request and implement a processing method—as described in connection with FIG. 2—to optionally modify an entry field in a contents directory and to an interveners' directory. Such processing of a composite request amounts to processing two simple requests successively sent to a CGS according to the invention, respectively relating to the level of relevance of a content and to the level of authorisation of an intervener having previously participated in the process of creation and/or qualification of said content.

The invention further allows the processing means 3 to be adapted so that they can implement conditions or operations prior to the access required. Thus, said conditions or operations are added to—or create a prerequisite for—the requirements formulated by the control means 3c, as illustrated in connection with FIGS. 1 and 2 (step 103c).

For example, the processing means may make use of the current value of an entry field or, more generally, a piece of meta-information associated with the element for which the request has been made or associated with the intervener making the request: a field of expertise, a category, a consultation counter etc. According to this alternative solution, said processing means can implement a set of supplementary control and/or calculation operations on the basis of predetermined predicates or heuristics on receipt of a request. Thus, the processing means take into account the wishes of the intervener making the request, optionally grant his/her request, or even, in certain cases, go beyond his/her request. On the other hand, said processing means may reject the requested request for consultation or assignment—on the basis of said supplementary monitoring and/or calculation operations—even if the level of authorisation of the intervener making the request intrinsically satisfies the requirements of the control means. According to this embodiment, the system such as the CGS described in connection with FIG. 1 ultimately “decides” according to predetermined parameters that may optionally exceed the mere framework of the level of authorisation of an intervener making a request. According to an example of application, a request for assignment may only have an outcome if a predetermined number of previous and similar requests—concerning a determined content—have been sent to a CGS according to the invention. Such a counter may be stored in an entry in a contents directory, as meta-information, as shown in connection with FIG. 1.

FIGS. 3a, 3b, 4a and 4b illustrate embodiments for customizing the control means 3c of a system as described in connection with FIG. 1.

It is also possible to customize said control means so that the latter can provide a view of an elements directory. It is thus possible to define a predicate ψₙ for determining the value or values of a qualification level necessary mᵣ for an intervener to be able to request that a piece of information from an elements directory be consulted. This predicate may also be defined to limit the view 34 offered by a CGS as described in connection with FIG. 1. Thus, for example, an intervener making a request with a low level of authorisation may not be authorised to consult all the entry fields of a contents directory—in contrast to other interveners having a higher qualification level or authorisation.

In the example of preferred application for quiz questions, it is possible to force an intervener whose qualification level mᵣ is low (equal to 1 or 2 as described in FIG. 3b for example) to research or to suggest an answer to a question that he/she wishes to correct, because such an intervener making a request may not consult a descriptive attribute that includes said answer. This approach allows an intervener with a higher qualification level to optionally verify ambiguous questions by comparing the answer suggested by the author of the question with that suggested in the form of comments or of an alternative version suggested by a lower-level intervener.

A method—as described in connection with FIG. 2—for processing a request for consultation sent to a system according to the invention thus comprises a preliminary step 100 of customizing control means of said system for determining the value or values of a level of authorisation mᵣ necessary for consulting information associated with one element of the directory. Optionally, the required value or values of a level of authorisation to consult information may depend on an element's current qualification level.

To be able to send a request for assignment Q or a request for consultation R, as represented in connection with FIG. 1, an intervener may advantageously have a human-machine interface module suited to this end.

Such a module may come in the form of a plug-in module 4 for a web browser.

By way of example, to display information relating to one element of the directory after a request for consultation has been sent, such a module may allow:
such an intervener's performances to be differentiated graphically;
revisions made by an intervener to be highlighted (if alternative versions exist) etc.

Thus, the invention allows an intervener to submit content to a system of the invention, or even to consult an existing content, and optionally to send a request for assignment for a level of relevance, for example, from a remote personal computer linked to a CGS, for example, over the Internet. Any other mode of communication enabling an intervener to communicate with a system according to the invention may be considered in the sense of the invention.

The invention further provides that the CGS may send a request to appeal to an intervener. This embodiment will be called “proactive” to characterise this alternative embodiment.

Thus, if the CGS notices that a content has not been evaluated after a defined period or when contradictory evaluations relating to the same content have been sent, the system may trigger a notification addressed to one or more interveners. According to a particular embodiment, the processing means of a system according to the invention may consult an interveners' directory to find a competent intervener's contact details and send an invitation e-mail to the latter. Other embodiments allowing such a proactive procedure to be implemented can be considered in the sense of the invention.

An example of application in the field of questions for an on-line general-knowledge test implementing a CGS qualification system as shown in connection with FIGS. 1 and 2 is as follows. The CGS is customized to manage levels of authorisation m included in a scale G_{I} of M=3 values: 1 to 3. Level 1 corresponds to novice interveners; level 2 corresponds to experienced interveners capable of judging how relevant a content is. Level 3 is dedicated to high-level interveners who alone are capable of deciding in particular whether to approve a question for utilization purposes.

An interveners' directory 1 comprises multiple entries 10 respectively associated with Paul, Sylvie, Pierre and Amandine. Paul has offered his services very recently. A novice, Paul's level of authorisation (stored in the field 12 of an entry 10) is 1. This level of authorisation allows him to submit questions to the CGS. It does not allow him, on the other hand, to suggest an assessment of a peer or of a content (question submitted by a third party). Sylvie and Pierre started off like Paul as question writers. Their diligence and the relevance of their performances have allowed them to be promoted to level-2 interveners. They are thus authorised to submit questions, but also to judge the relevance of a question submitted by a level 1 or 2 third party. The CGS further grants them the possibility of suggesting that a level 1 intervener be promoted to level 2. As for Amandine, she is authorised to decide on the final approval of a question. She may further submit questions and judge the relevance of all content. She may further analyse the performances of lower levels interveners and suggest a promotion so that a lower level intervener may rise to a higher level. She may also decide to sanction a level 2 intervener and suggest that he/she be downgraded to the lowest level (i.e. level 1). This sanction may be decided in response to a decline in diligence or to repeated failure on the part of an otherwise experienced intervener.

Each intervener is associated with a unique identifier stored respectively in the field 11 of an entry 10 in the interveners' directory. Different descriptive attributes 24a, 24b, . . . may be stored in the entries 10. They allow an alias, one or more areas of expertise, an e-mail address etc. to be stored. Among this meta-information, the number of questions ultimately approved for each intervener writing questions will be counted.

The CGS comprises a contents directory 2. Each question submitted has an entry 20 in said directory. Each entry associated with a question comprises a unique identifier 21 and a field 22 for storing a level of relevance. A newly sent question has a minimum level of relevance equal to 1. This level belongs to a scale G_{C} of N=3 values: 1, 2 or 3. Level 1 corresponds to a question awaiting validation. Level 2 corresponds to a question that has been the object of a first validation by level-2 intervener. Level 3 corresponds to questions that have been approved by a level-3 intervener, and that are thus ready for use. A question is in the form of an interrogative text stored in an attribute 23 and of an answer recommended by the question writer, an answer stored in an attribute 24. Other descriptive attributes or meta-information (areas, languages etc.) may be associated and stored (24a, 24b etc.) Among these, the identifier of the intervener writing the question is stored.

The CGS' processing means comprise two predicates φₙ and φₘ to control the promotions of the questions and of the interveners respectively.

Thus:

$${ϕ}_{n} is in that \text{:} \vert \begin{matrix}q \leq {m}_{r} ⇒ {ϕ}_{n} ( q , {m}_{r} ) = OK pour que n = q \\ q > {m}_{r} ⇒ {ϕ}_{n} ( q , {m}_{r} ) = KO \text{:} n inchang {e}^{′}\end{matrix} ;$$

$${ϕ}_{m} is in that \text{:} \vert \begin{matrix}( q \leq {m}_{r} ) ⋀ ( m < {m}_{r} ) ⇒ {ϕ}_{m} ( q , m ) = OK pour que m = q \\ ( q > {m}_{r} ) ⋁ ( m \geq {m}_{r} ) ⇒ {ϕ}_{m} ( q , m ) = KO \text{:} m inchang {e}^{′}\end{matrix} ;$$

where q is the new value requested to promote the relevance n of a question or the authorisation m of an intervener, mᵣ is the level of authorisation of the intervener making the request and m the level of authorisation of the intervener writing the question.

To submit a question to the CGS, the four interveners submit a request for assignment Q as described above. For a new question, this request allows an entry 20 in the contents directory 2 to be created. Any intervener may suggest assigning a level of relevance less than or equal to his/her level of authorisation. According to this example of application, the system is provided to initialise the level of relevance for all new questions to the value of 1—whatever the level of authorisation of the intervener writing the question. The means processing the request is thus customized so that this condition comes to complete the condition anticipated by the predicate φₙ. Likewise, to avoid the situation wherein a level 2 intervener may promote a question of which he/she is the author, the processing means of the CGS is customized to forbid this request for promotion.

In parallel, the CGS is customized to provide the interveners with a selective view 34 of the information in the contents directory 2. Thus, according to our example of application, the control means 3c makes use of a predicate ψₙ such that:
a level 3 intervener may consult all entries in the contents directory;
a level 2 intervener may consult all entries in the contents directory with the exception of the field corresponding to the attribute that stores an answer recommended by a third party;
a level 1 intervener has read-access to the information in the contents directory 2 relating to the questions of which he/she is the author.

Paul is free to suggest questions. Pierre and Sylvie may submit questions and be granted consultation access (through a request for consultation) to all entries of the contents directory, with the exception of the answers recommended by the question writers (except if they are themselves the authors of a question that is the object of the consultation). They may suggest an assessment of the level of relevance n for a question by Paul or by any other level 1 intervener. Therefore, Sylvie sends a request for assignment Q to the CGS. This request comprises her identifier as intervener making the request and the new value for the requested level of relevance. For the request to be admissible—given φₙ—this level may not exceed the value of 2. The request may comprise a comment or an amended or alternative version of the interrogative text of the question under examination. The request may also comprise an answer recommended by our level-2 intervener. This information is stored in the entry 20 associated with the question being examined via the descriptive attributes. The requested level of relevance may also be maintained at the value of 1 if Sylvie considers the question to be obviously incomplete or ambiguous. Sylvie may send a second assignment request to optionally suggest promoting Paul if she considers that Paul has demonstrated regular, high-quality work. The CGS may optionally grant Sylvie her assignment request. Taking into account the low number of questions submitted by Paul, this request could be found premature and judged as such by the CGS, or even by Amandine, who is authorised to read all information in the contents directory. Pierre may also optionally read Paul's question and suggest comments and assessments. By means of the human-machine interface module provided by the invention, he may send a request for consultation to the CGS. The module enables him to view (with the exception of the recommended answers) the interrogative text written by Paul, and also the comments of Sylvie's amended version. According to certain options, said module may highlight Sylvie's suggested modifications for him. He in turn may send a request for assignment to promote Paul's question, or even to maintain its level of relevance at its current level. He may also send comments or even an alternative version. The CGS examines the possibly contradictory assessments and assigns the level of relevance for Paul's question. Should two requests for assignment corroborate and suggest that the question should be promoted to a level of relevance of 2, the system modifies the level of relevance for the question.

Amandine in turn—the level 3 intervener—may consult the information relating to the question written by Paul. The human-machine interface module provided by the invention allows her to read the respective performances of the three interveners (Paul, Sylvie and Pierre). After reading these, Amandine may send a request for assignment to modify the level of relevance for the question being examined. The level requested may be equal to 3 in order to approve the question and make Paul's question deliverable and usable. Conversely, Amandine may request that the level of relevance be maintained or even downgraded if she judges that the question can be improved, or that it is redundant or ambiguous. Amandine may further tweak Paul's text, a text optionally reworked by another intervener etc.

Using a composite request, Amandine may at the same time send a request to promote a question but an intervener who has contributed to the process of creation or of qualification of said question too. Thus, Pierre can be promoted with regard to his performance relating to the current question, but also for all his earlier performances. The CGS may interpret this request and promote Pierre to the level of authorisation 3 if the different parameters (number of performances etc.) render Amandine's request admissible.

The invention should not be limited to this sole example of qualification of a content in the form of a question for an on-line game. This example allows emphasising, however, the advantages of the invention compared to the known solutions in the field. In fact, the submission of questions is controlled by the system, while being open to a large number of interveners. The latter are trained and promoted while being guided entirely by the system in an objective manner. The latter may be promoted (or even downgraded) and at the same time the invention allows the panel of interveners to be retained, enriched and renewed.

The question bank or, more generally, the bank of all the multimedia content produced with the help of the system thus emerges as rich, varied, non-redundant and particularly relevant.

1-15. (canceled)

16. A method for processing a request sent to an element qualification management system comprising a storage device and a processor that implements a controller for authorizing or denying access to said storage device, comprising:
creating and saving, in the storage device, an interveners' directory containing at least one element, said element having a unique identifier and an attribute, wherein the value of the attribute describes a qualification level belonging to a group G_{I} of at least two distinct values;
configuring the controller to determine the qualification level necessary to obtain access to a directory stored in the storage device, by determining a value or values q, belonging to the group G_{I}, that can be requested by an intervener whose unique identifier is stored in the interveners' directory, in dependence upon the intervener's qualification level;
receiving, at the processor, a request for access to a directory, wherein the request for access is a request to assign a value q to the attribute describing the qualification level associated with the element in the interveners' directory, as a substitution for the current qualification level of said attribute, said request including the intervener's identifier stored in the interveners' directory;
processing said request in the controller, by performing the following operations:
decoding said request to determine the identifier of the intervener making the request;
read-accessing the storage device to refer to the interveners' directory and determine the qualification level of the intervener making the request;
determining whether the qualification level of the intervener making the request allows the intervener to legitimately assign the requested value q; and
assigning the requested value q to the attribute, to describe the qualification level associated with the element for which the request has been made, if the controller confirms that the intervener is allowed to legitimately assign the requested value.

17. The method according to claim 16, wherein the step of creating and saving a directory includes associating one or more descriptive attributes with an element.

18. The method according to claim 16, further including a step of creating and saving, in the storage device, a second elements directory in the form of a contents directory whose qualification level value belongs to a group G_{C} of at least two distinct values;
wherein:
the request for access includes a request to assign a value q to the attribute describing the qualification level associated with a content of said contents directory as a substitution for the current qualification level of said attribute, said request including the intervener's identifier stored in the interveners' directory;
the step of configuring the controller further comprises determining the value or values q of the qualification levels belonging to the group G_{C} that can be requested by an intervener depending on the intervener's qualification level; and
the step of processing a request to assign a value q to the attribute describing the qualification level associated with a content of said contents directory comprises:
decoding said request to determine the identifier of the intervener making the request;
read-accessing the storage device to refer to the interveners' directory and determine the qualification level of the intervener making the request; and
authorising write-access to the directory to which the request relates and assigning the requested value q to the attribute, to describe the qualification level of the content for which the request has been made if the controller confirms that the qualification level of the intervener making the request allows the intervener to legitimately request such an assignment.

19. The method according to claim 17, wherein the request for access further comprises meta-information of the intervener making the request, and the processor saves said meta-information in the storage device as a descriptive attribute of the element in the directory at the time of assignment of the requested value q to the attribute, in order to describe the new qualification level of said element.

20. The method according to claim 19, wherein the meta-information comprises an amended version of the content to which the request for access relates, and said request processor saves said amended version in the storage device as a descriptive attribute of said content in the contents directory at the time of assignment of the requested value q to the attribute, in order to describe the new relevance of said content.

21. The method according to claim 19, wherein the descriptive attribute for storing the meta-information further comprises the identifier value of the intervener who is the author of said meta-information.

22. The method according to claim 16, wherein:
the request for access includes a request for consultation of the information of the directory associated with one or more elements of a directory, wherein said directory comprises the identifier of the intervener stored in the interveners' directory;
the step of configuring the controller further comprises determining the value or values of the levels of authorisation necessary to consult one or more pieces of information associated with an element from an elements directory; and
the step of processing a request to consult information associated with one or more elements of a directory comprises:
decoding said request to determine the identifier of the intervener making the request;
read-accessing the storage device to consult the interveners' directory and to determine the qualification level of the intervener making the request; and
authorising the read-access to the storage device, and providing one or more pieces of information from a directory if the controller confirms that the qualification level of the intervener making the request allows the intervener to legitimately request such a consultation.

23. An elements qualification management system comprising:
a storage device for saving an intervener's directory containing at least one element, said element having a unique identifier and an attribute, wherein the attribute describes a qualification level belonging to a group G_{I} of at least two distinct values;
a processor that receives a request for access to a directory, and that implements a controller that determines a qualification level necessary to obtain access to a directory stored in the system;
wherein:
a request for access is a request to assign a value q belonging to the group G_{I}to the attribute describing the qualification level associated with an element in the interveners' directory as a substitution for the intervener's current qualification level, said request including an identifier of the intervener stored in the interveners' directory;
the processor decodes said request to determine the identifier of the intervener making the request;
the controller refers to the interveners' directory to determine the qualification level of the intervener making the request and determines whether the qualification level of the intervener making the request allows the intervener to legitimately request such an assignment; and
the processor write-accesses the storage device and assigns the requested value q to the attribute, to describe the qualification level associated with the element for which the request has been made, if the controller confirms that the qualification level of the intervener making the request allows the intervener to legitimately request such an assignment.

24. The system according to claim 23, wherein the storage device stores one or more descriptive attributes associated with an element of a directory.

25. The system according to claims 23, wherein:
the storage device stores a second elements directory in the form of multimedia content whose qualification level value belongs to a group G_{C} of at least two distinct values;
a request for access includes a request to allocate a value q to the attribute describing the qualification level associated with a content of said contents directory in substitution for the current qualification level of said attribute;
the processor decodes said request to determine an identifier of the intervener making the request;
the controller consults the interveners' directory to determine the qualification level of the intervener making the request and determines whether the qualification level of the intervener making the request allows the intervener to legitimately request such an assignment; and
the processor accesses the storage device and assigns the requested value q to the attribute, to describe the qualification level associated with the element for which the request has been made, if the controller confirms that the qualification level of the intervener making the request allows the intervener to legitimately request such an assignment.

26. The system according to claim 23, wherein:
a request for access includes a request to consult the information of the directory associated with one or more elements of a directory;
the processor decodes said request to determine the identifier of the intervener making the request;
the controller consults the interveners' directory to determine the qualification level of the intervener making the request and determines whether the qualification level of the intervener making the request allows the intervener to legitimately request such a consultation; and
the processor read-accesses the storage device and provides one or more pieces of information from a directory if the controller confirms that the qualification level of the intervener making the request allows the intervener to legitimately request such a consultation.

27. The system according to claim 23, further comprising a human-machine interface module coupled with an electronic device cooperating with said system to make a request and give the result thereof on said electronic device.
